(19) United States
(12) Patent Application Publication
(10) Pub. No.: US 2024/0022576 A1
(43) Pub. Date: Jan. 18, 2024

(54) METHOD FOR COMMUNICATION BETWEEN A THIRD-PARTY COMPONENT ON A USER DEVICE AND A SERVICE COMPONENT IN THE CLOUD, AND NETWORK ARRANGEMENT FOR IMPLEMENTING THE METHOD

(71) Applicant: Robert Bosch GmbH, Stuttgart (DE)

(72) Inventor: Christoph Burger-Scheidlin, Muenchen (DE)

(21) Appl. No.: 18/254,341

(22) PCT Filed: Oct. 25, 2021
(86) PCT No.: PCT/EP2021/079477

§ 371 Date: May 24, 2023

(30) Foreign Application Priority Data
Nov. 26, 2020 (DE) 10 2020 214 845.7

(51) Int. Cl. H04L 9/40; H04L 67/53; H04L 67/10

(52) U.S. Cl. CPC H04L 63/126; H04L 67/53; H04L 63/0823; H04L 67/10

(57) ABSTRACT

The invention relates to a method for communication between a third-party component (4) on a user device (2) and a service component (10) in the cloud (3), wherein: the service component (10) is signed by a data ID (13); the third-party component (4) provides component data (20); the component data (20) are marked by the data ID (13) in order to generate marked component data (21); the marked component data (21) are transferred to the cloud (3); and the marked component data (21) are assigned to the service component (10) having the data ID (13).

### BACKGROUND

In the sale of apps, cloud solutions are often favored, wherein the apps are sold through a provider in the cloud, such as Google Play Store. Once sold, the apps are largely independent of the provider and use the communication partners provided by the app.

Publication DE 10 2018 219 067 A1, which is likely the closest prior art, describes a system and method for the local composition of a data page with personal user data for a large number of services accessed by the user and which are provided on a large number of servers.

### SUMMARY

In the context of the invention, a method, a network arrangement, a computer program, and a machine-readable storage medium are proposed.

The subject-matter of the invention is a method for communication between a third-party component on a user device and a service component in the cloud.

A user device is in particular understood to mean a UE (user equipment). The user device can in particular be configured as a cell phone, tablet, computer, but also as a vehicle, manufacturing machine, work machine, robot, etc. User devices are thus in particular understood to mean all terminal devices that allow the third-party component to run.

The third-party component is understood to be an application software, an application program, a software, a computer program and/or an app that can run on the user device.

Cloud is in particular understood to mean an IT infrastructure that is made available via the Internet, for example. The cloud is in particular configured as a computer network. The cloud can in particular provide a variety of service models, specifically infrastructure as a service (IaaS), platform as a service (PaaS), software as a service (SaaS), and/or function as a service (FaaS).

In the cloud, at least one service is provided by a service component. The service can represent a processing. The simplest example of processing is a forwarding of data. Alternatively, or in addition, different types of cloud processing components are provided as service components, which implement the at least one service. This includes, for example, cloud processing services for visualization, cloud processing services for routing, or cloud processing services for aggregating data. The service component is understood to be an application software, an application program, a software, a computer program and/or an app that can run in the cloud.

The method allows for a communication, in particular data exchange, between the third-party component on the user device and the service component in the cloud. In this case, the communication can occur only unidirectionally, in particular from the third-party component to the service component, or bidirectionally, so that data from the third-party component to the service component and data are transferred from the service component to the third-party component. The data can be configured as desired and in particular can also comprise images, videos, acoustic information, messages, and in particular control messages.

The service component is provided with a data ID, which is signed along with the service component. In particular, the signature is done via a certificate. The certificate is in particular configured as a cryptographic and/or digital certificate having a public portion and a private portion, in particular a public key and a private key.

Signing with the certificate is carried out in particular via the private part of the certificate and can be verified via the public part of the certificate. For example, the public part is deposited with a certification authority.

The third-party component provides component data. For example, the third-party component can receive, process, and provide input signals and/or input data as component data via the user device. It is contemplated that the component data can be marked by the data ID to generate marked component data. In particular, the component data are connected by data technology to the data ID. The marked component data, comprising the component data and the data ID, are transferred to the cloud, in particular via an endpoint.

It is contemplated that the marked component data can be assigned to the service component having the data ID in the cloud. In particular, the marked component data are forwarded to the service component having the data ID located in the marked component data in the cloud.

It is a consideration of the invention that, by marking the data with the data ID, an assignment in the cloud and an adjusted processing is possible with the service component signed by the data ID. A unique allocation of the data, in particular the component data, to the service component is thus possible.

With this procedure, the network arrangement is able to process any data without having to pay attention to compatible or standardized data types. A particular advantage of the invention is that the processing of the data can occur regardless of the compatibility with other components or standards. The relation between the user device and cloud processing can be designed differently. These can be a simple redirection. However, compression/decompression or analysis and visualization are also possible, for example. For example, the service component in the cloud as a service can also be a visualization of specific app data and/or component data as part of a data dashboard, which can display the data from multiple third-party components from the same user device or from multiple user devices.

In a preferred further development of the invention, the third-party component is signed by a component ID. In particular, the signature is done via the certificate or a further certificate. The certificate is in particular configured as a cryptographic and/or digital certificate having a public portion and a private portion, in particular a public key and a private key.

Signing with the component ID is done in particular via the private portion of the certificate and can be verified via the public portion of the certificate. For example, the public part is deposited with a certification authority. The component ID can have different signing data.

In a preferred realization of the invention, the user device comprises a device management component. The device management component can also be referred to as device manager. It is contemplated that the device management component communicates with a device management server in the cloud. The device management server can also be referred to as a device server. It is preferably provided that the marked component data are routed to the service component in the cloud via the device management component and the device management server.

In a preferred configuration of the invention, the data transfer of the marked component data occurs via the device management component and the device management server via a single connection. In particular, the device management server provides an endpoint, wherein the device management component communicates in particular exclusively with the endpoint. Particularly preferably, this connection is configured as a secured connection. For example, this connection is configured as a VPN connection. With this configuration, it is achieved that only a single, in particular secured connection to the device management server must be kept in the cloud via which the transfer of the component data is possible. This describes a network arrangement in which the user device can be operated via a few connections, preferably via a single connection, to the cloud and/or into the outside world. This enables the accurate verification of the communication of the user device and simplifies the effort to set up firewall rules.

This connection allows a control of the flow of the component data and further data, especially with respect to throughput, overhead, and latency. This is particularly beneficial in the corporate environment, where many uncontrolled connections could create concerns relating to IT security. In particular, the third-party component now does not directly deliver the component data to the cloud, but rather via the device management component. The device management component is able to control the component data, specifically with regard to the amount of data and latency. For example, the device management component can bundle multiple files at the cost of the latency in order to reduce overhead. Specifically, this control can also be done depending on the license acquired for the user device, so that if a base license is available, it is decided in favor of the reduced overhead, while if an extended license is available, it is decided in favor of a lower latency.

In one possible further development of the invention, the service component sends control messages to the third-party component via the device management server and the device management component. In particular, the same, preferably secured connection is used as in the transfer of the marked component data.

It is further particularly preferred that the third-party component is transferred to the user device via the device management server and the device management component for the purposes of installation and/or update. Particularly preferably, the third-party component is transferred along with the data ID.

In a particularly preferred constellation, the marked component data, control messages, and the third-party component are thus transferred via the same, in particular secured, connection for the purposes of installation and/or update. With this architecture, it is ensured that the transfer of the data in terms of IT security is to be secured in a simple manner. Further, by using the data ID, the allocation of the component data to the respective service component is ensured, so that IT security is also increased to the effect that the component data and further data are routed to the correct recipient.

In a possible configuration of the invention, the service component and the third-party component are signed by the same certificate and/or with a certificate from the same developer. Preferably, the data ID comprises the component ID as information, so that a strict and thus secure association is given between the third-party component, the service component, and the component data.

In an alternative configuration of the invention, the service component is signed via a first certificate and the third-party component is signed via a second certificate. It is particularly preferred that the signed service component is signed by a bundle certificate along with the signed third-party component. In this configuration, the assignment of data ID to service components can occur solely through the signature of the bundle certificate. This architecture of the signatures allows the third-party component and the service component to be signed by different certificates and to be merged by the bundle certificate. It is further possible that already existing service components with the bundle certificate, which can be signed by an external certificate, can be incorporated in the method. The external certificate originates from another developer.

### BRIEF DESCRIPTION OF THE DRAWINGS

Further features, advantages, and effects arise from the following description of preferred embodiment examples as well as the enclosed figures. The figures show:

FIG. 1 a first embodiment example of the invention of a network arrangement for carrying out a method for communication in a schematic block diagram;

FIG. 2 a second embodiment example of the invention of a network arrangement for carrying out a method for communication in a schematic block diagram;

FIG. 3 a third embodiment example of the invention of a network arrangement for carrying out a method for communication in a schematic block diagram;

FIG. 4 a fourth embodiment example of the invention of a network arrangement for carrying out a method for communication in a schematic block diagram;

FIG. 5 a fifth embodiment example of the invention of a network arrangement for carrying out a method for communication in a schematic block diagram;

FIG. 6 a sixth embodiment example of the invention of a network arrangement for carrying out a method for communication in a schematic block diagram;

FIG. 7 a seventh embodiment example of the invention of a network arrangement for carrying out a method for communication in a schematic block diagram.

Like or corresponding components are shown and described in the figures bearing the same reference numerals.

### DETAILED DESCRIPTION

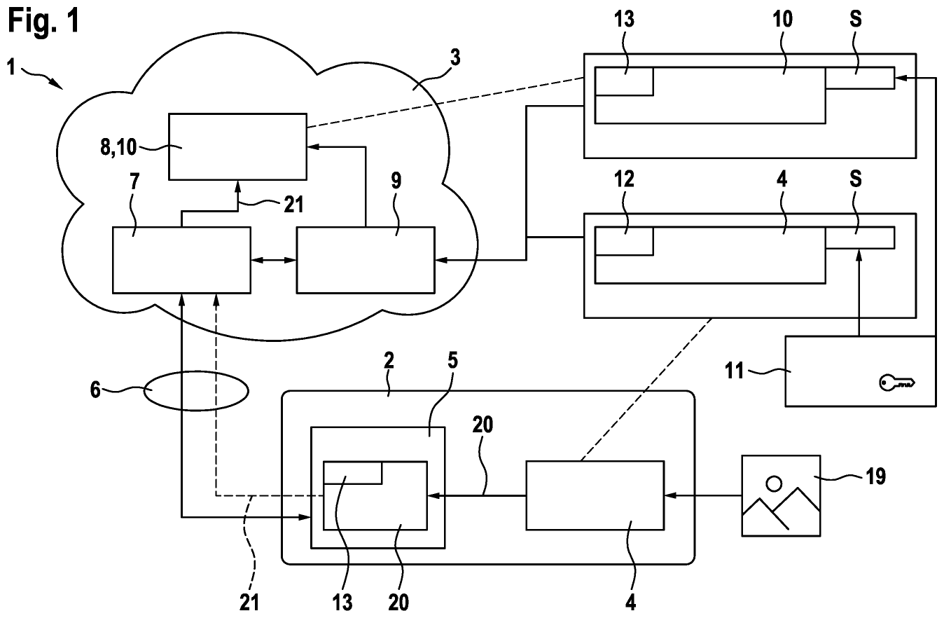

FIG. 1 shows a schematic block diagram of a network arrangement 1 as an embodiment example of the invention. The network arrangement 1 comprises a user device 2 as well as modules in a cloud 3.

The user device 2 is configured as a terminal device, for example a cell phone, or as any other terminal device. Input signals 19, such as images, video sequences, sound sequences, sensor readings, or even input data, can be received via corresponding interfaces.

The user device 2 comprises a third-party component 4, wherein the third-party component 4 is configured as a computer program, in particular as an app. The third-party component 4 can originate from the manufacturer of the operating system of the user device 2, or can also originate from another provider. The third-party component 4 receives the input signals 19 preferably in a digitalized form and converts them into component data 20 as output data from the third-party component 4.

The user device 2 comprises a device management component 5, wherein the device management component 5 can also be referred to as a device manager. The component data 20 are transferred to the cloud 3 via the device management component 5 via a connection 6. The connection 6 can be configured as a secured connection, in particular as a VPN channel.

In the cloud 3, a device management server 7 and a service module 8, as well as a component distribution module 9, are provided as modules. The modules can be arranged as software modules and/or as hardware modules centrally or decentralized in the cloud 3. The service module 8 comprises a service component 10, wherein the service component 10 is configured as a computer program, in particular as an app.

The component distribution module 9 serves to distribute the third-party component 4 to the user device 2 and from the service component 10 to the service module 8. The third-party component 4 is initially delivered to the device management server 7, and via the device management server 7, the third-party component 4 or an update thereof is delivered to the user device 2 via the connection 6.

The third-party component 4 or multiple variants thereof, which are assigned to different technical equipment of the user device 2, for example, are signed S via a certificate 11 with a component ID 12. In the embodiment example in FIG. 1, the service component 10 is signed S via the same certificate 11 with a data ID 13.

The user device 2 denotes the component data 20 of the third-party component 4 with the data ID so that marked component data 21 are generated. Marking with the data ID can be done by the third-party component 4 or, as shown in FIG. 1, by the device management component 5. Via the connection 6, the marked component data 21 are routed from the device management component 5 to the cloud 3 to the device management server 7 and subsequently to the service module 8 with the service component 10, which has the data ID of the marked component data. With this architecture, it is achieved that the distribution of the third-party component 4 and the transfer of the marked component data occurs via the same connection 6. By marking the component data with the data ID, it is achieved that the marked component data 21 or the component data 20 in the cloud 3 is forwarded to the service module 8 with the corresponding service component 10 having the same data ID, so that the association of the component data 20 with the service component 10 is deterministically ensured.

From the prior art, third-party components for devices (apps) and basic software modules and distribution mechanisms are known (e.g. Docker images, OSGI bundles). Furthermore, Android “App Bundles” are known, which are signed bundles of software components, from which only a subset needs to be installed on a device, wherein this subset is derived from the features of the device on which the software is installed. Finally, the concept of multi-APK is also known from Android, which basically has multiple apps available, but only that version of the app is installed which has been optimized by the developer for the respective device.

The third-party components are written by a software developer and then signed by means of a certificate. Of course, the secret key is only known to the software developer himself. The public portion of the certificate is deposited with an app distribution/sale service, which can confirm the origin of the software. A device will now communicate with this distribution service via an endpoint in the cloud, via which the apps will be installed on the device (e.g. Google Play Store). Data that the app sends is usually sent via a separate server (e.g. WhatsApp).

Communication with any endpoint, however, presents greater challenges to some systems because communication with any endpoint is not desired for security reasons.

FIG. 1 shows a system known only in part from the prior art. The device management component 5 on the user device 2 connects it to the device management server 7 in the cloud 3. The device management server 7 is connected to a system for distributing and managing third-party components 4, the component distribution module 8. A developer can now develop the third-party component 4 for the user device 2 and transfer this device management component (component distribution module 8) to the cloud 3. To identify the developer, the in particular cryptographic certificate 11 is used, from which the public part of the management component (component distribution module 8) has been introduced in the course of an initial login process. The owner of the user device 2 can now obtain the third-party component 4 via the cloud 3 and have it installed on the user device 2. The installation is coordinated via the device management server 7. Depending on the type of device or the functionality available on the user device 2, one of a variety of possible variants of the third-party component 4 can be used.

Known implementations of this principle are the Apple and Google ecosystems, with the AppStore for iOS, or the PlayStore for Android. In these systems, each of the third-party components 4 is typically responsible for the communication itself and communicates with its own servers, as can be seen from the variety of available messengers.

The embodiment examples in the figures relate to the user device 2, wherein third-party components 4 can be installed subsequently and which can be used in a secured environment. The user device 2 collects and processes input data and/or signals 19 and sends them to the cloud 3 as component data 20 or 21. The preferably sole connection 6 to the cloud 3 is to be used. This enables a more accurate verification of the communication of the user device 2 and simplifies the effort to set up firewall rules. One concept is a marking of service components 10 in the cloud 3 by the developer, marking the component data 20 generated by the third-party component 4 on the user device 2, as well as a bundling of both components with the aid of cryptographic signatures S. By marking the component data with the data ID for conversion into the marked component data 21, an assignment of the component data 20 in the cloud 3 and an adjusted processing by the service component 4 with the same data ID is possible.

With this procedure, the network arrangement 1 is able to process any data without having to pay attention to compatible or standardized data types. Only at least or precisely one single (secured) connection 6 must be kept in the cloud 3 (to the device management server 7), via which the transfer of component data is now also possible. This connection allows a control of the flow of data, especially with respect to throughput, overhead, and latency. This is particularly beneficial in the corporate environment, where many uncontrolled connections could create concerns relating to IT security.

A particular advantage is that the processing of the component data 20 can occur regardless of the compatibility with other components or standards, because the component data 20 is assigned to the corresponding, compatible service component 10. The relation between the user device and cloud processing can be designed differently. These can be a simple redirection. However, compression/decompression or analysis and visualization are also possible, for example. For example, the service component 10 in the cloud 3 can also be a visualization of specific component data as part of a data dashboard, which can display the data from multiple third-party components 4.

The network arrangement 1 in which the user device 2 is to be operated into the outer world via as few connections as possible, preferably via a single connection 6. This allows for a more accurate checking of the communications of the user device 2 and simplifies the effort to set up firewall rules. One or more apps are located on the user device 2 as third-party components 4, which process an input signal and/or signal 19, for example a video signal or a user input. The apps generate output signals in the form of digital data as component data 20.

The apps now deliver the data 20 to the cloud 3, not directly but via a device manager as the device management component 5. The device manager is able to control the data, specifically with regard to the amount of data and latency. For example, the device manager can bundle multiple data at the cost of the latency in order to reduce overhead. Specifically, this control can also be done depending on the license acquired for the user device, so that if a base license is available, it is decided rather in favor of the reduced overhead, while if an extended license is available, it is decided in favor of a lower latency. To associate and further process the component data 20 in the cloud 3, the apps, i.e. the third-party component 4 or the device management component 5, mark the component data 20 by the data ID, which is evaluated in the cloud 3 by the receiving body.

The developer or a further developer now creates a processing component as a service component 10 for the cloud 3, signs it with his certificate 11, and makes it available to the cloud 3. This processing component is intended and characterized for processing a data ID. Using this data ID, the cloud 3 can now perform the specific processing for the component data 20 by processing the component data 20 by means of the processing component. Thus, by means of the data ID, forwarding by the device management server 7 to the correct processing unit as the service module 8 with the service component 10 in the cloud 3 is enabled.

In the cloud 3, the component data are passed to a processing instance which decides which service component 10 to perform for the component data 20 based on the data ID. These service components 10, like the apps of developers, are programmed and, respectively, provided with a cryptographic signature by the data ID. It should be noted that an app on the user device 2 can also generate different component data 20 with a unique data ID.

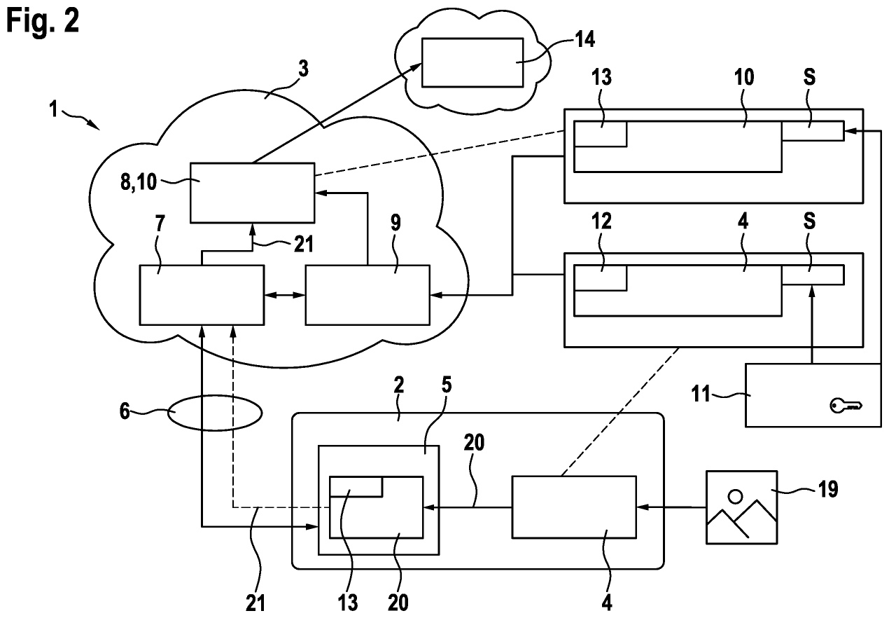

The simplest example of processing by the service component 10 is a simple routing of the component data 20, as shown in FIG. 2. Here, the component data are forwarded from the service module 8 with the service component 10 with the corresponding data ID, for example, to a specifiable server 14.

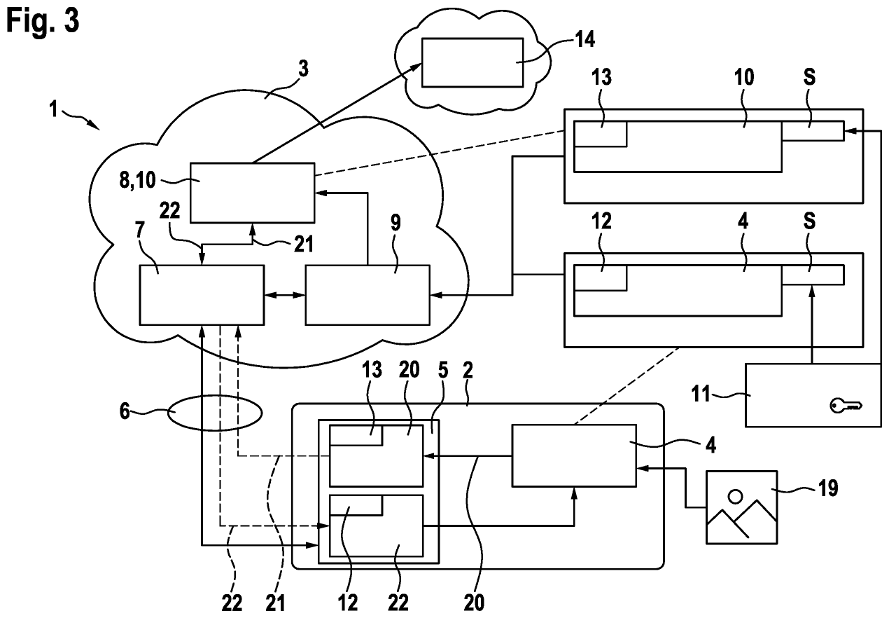

It is possible that different types of service components 10 and/or service modules 8 can be supported, for example, cloud processing modules for visualization, cloud processing modules for forwarding, or cloud processing modules for aggregation. Also, it is possible that the cloud processing modules can again use the device management server 7 in order to deliver control messages 22 to the third-party component, as exemplified in FIG. 3. In particular, the connection 6 is used for the control messages 22 so that only a single connection 6 is still used. The control messages are sent by the service component 10 and are marked with the component ID 12. The control messages are sent to the user device 2 via the device management server 7. In so doing, the component ID 12 can ensure delivery to the desired user device on the one hand, in particular to the desired third-party component with the same component ID. On the other hand, the component ID 12 can mark and secure the control message.

The data ID is a central element, because it couples the processing on the user device 2 to the processing in the cloud 3. It is also possible for the component data 20 to be initially stored in a database prior to processing. This is particularly useful when the cloud processing is a visualization.

The data ID is preferably a hierarchical structure of the base data type, component ID, specialization, and/or version number. The base data type allows for appropriate storage to be selected in a database. The component ID allows for the assignment to a third-party component 4, the specialization allows the third-party component 4 to differentiate specific data, and the version number ultimately allows for a later processing, which is particularly useful when the data are stored in a database.

The device management component 5 preferably checks (or adds) the component ID to the data ID in order to prevent a third-party component 4 from setting a data ID such that an unwanted processing is performed by another cloud processing component, in particular the service component 10, which may lead to security issues. Likewise, the cloud 3 preferably checks that the service component 10 has been signed by the same developer as the component ID identified by the data ID, preventing other third-party components 4 from having component data processed by a non-commissioned service component 10. (This review can occur once).

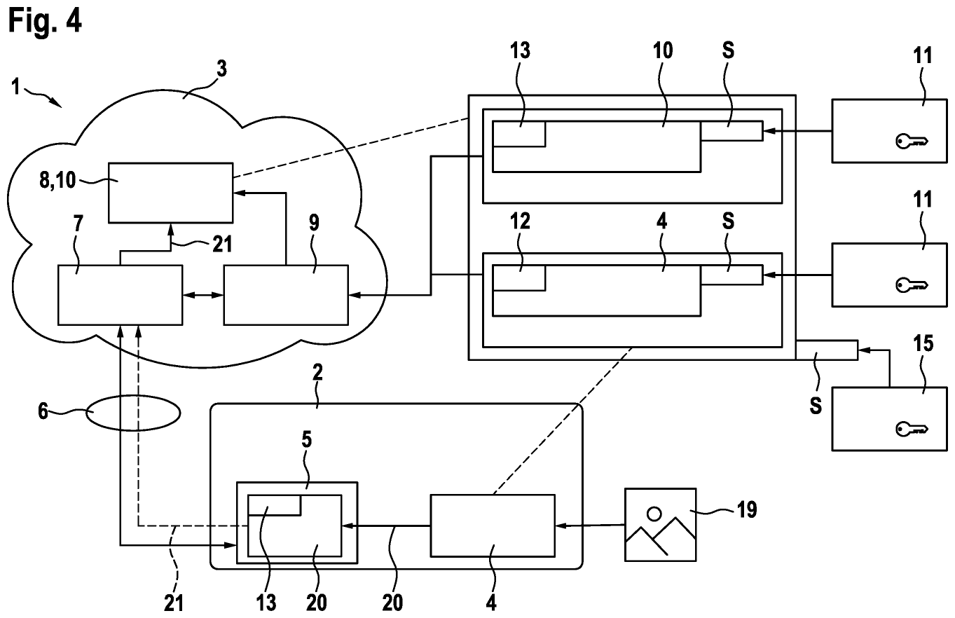

In FIG. 4, the same construction is shown as in FIG. 1. The additions from FIGS. 2 and 3 can also be used in the same manner in the construction in FIG. 4. By contrast to the previous figures, the third-party component 4 and the service component 10 are signed S by different certificates 11. Thus, the third-party component 4 can be signed S by a first developer and the service component 10 can be signed S by a second developer with different certificates 11. The signed components 4, 10 are signed together via a bundle certificate 15 with the signature S.

The network arrangement 2 described in the previous figures uses the same certificate 11 for all related components 4 and 10. This common certificate 11 identifies the related components.

Signature of Component Bundle Signature:

A variant is shown in FIG. 4, wherein this implicit association is solved by a further signature as the bundle certificate 15, so that in principle three certificates 11, 11, 15 are used, one for each of the individual components 4, 10 and one for the collection of the components 4, 10. This allows existing certificates and methods to be used in order to sign the individual components, although typically at least two signatures are identical. This in particular solves the problem of backwards compatibility. The third-party component 4 distributed to the user device 2 behaves identically to the case in which there is no cloud processing. This property applies to cloud processing accordingly. It is thus also possible to outsource the cloud processing to third-party components 4, which require certain signatures, whose verification for component management is not possible. This can be, for example, if the processing is on an “external” cloud. In addition, it is possible to add existing components for data processing in the cloud unchanged to the bundle, for example to ensure a backwards compatibility, or to be able to use the components of other developers in a licensed manner. As a result, for example, a solution for a complex scenario requiring multiple third-party components 4 and cloud components 10 can be certified, for example, in order to assure certain processing guarantees.

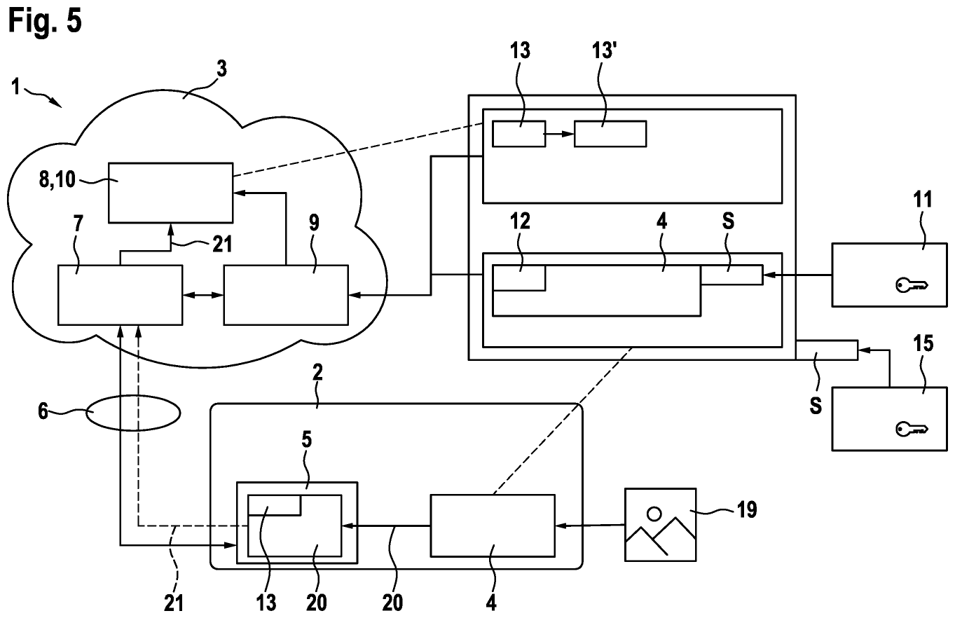

Finally, it is also possible to allow processing by other components without directly supplying them as part of the bundle with the bundle certificate 15. This is particularly advantageous when, for example, existing visualizations are to be enabled, as shown in FIG. 5. Here, the data ID 13 of the service component 10 is provided by a different developer than the existing data ID 13′ and is incorporated via the bundle certificate 15. The service component 10 itself is not signed; instead, only a reference to the service component 10 is given.

Due to the now more solid coupling of the components via the bundle certificate 15, it is also possible to remove the component ID of the third-party component 4 and to automatically incorporate it into the data ID without the developer having to do so explicitly.

Expanded Processing:

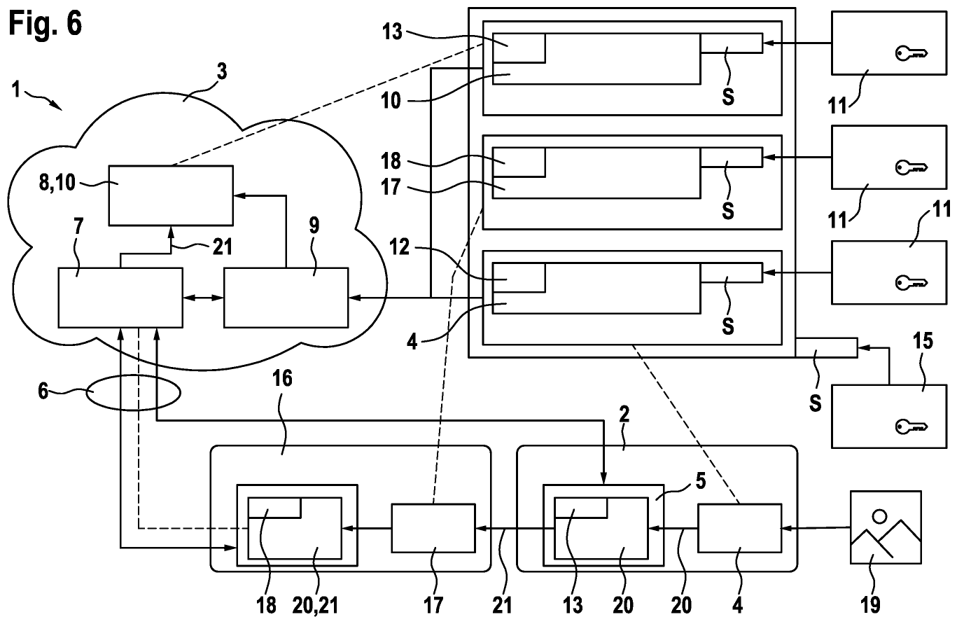

The variant shown in FIG. 5 can be extended by multiple component classes, as shown in FIG. 6. For example, to reduce data traffic, a local processing node 16 can be installed with a processing component 17, or intermediate processing can take place, such as compression of the data in the processing component 17. The processing node 16 can be configured differently. It can be a physical computing unit, a virtual machine, or even just time on a cloud 3 or edge Cloud. This device can be installed on a terrain (“on-premise”) together with the devices or can be provided by a third party, for example in a nearby data center (“off-premise,” not shown). Also, these can be dedicated resources, or portions of third-party systems, for example systems for managing the devices.

A processing ID 18 of processing component 17 behaves analogously to the data ID in the cloud 3. In particular, the processing ID 18 is signed by means of the bundle certificate 15. The processing component 17 checks the data ID analogously to the mechanisms described and, if necessary, requests missing processing components, from the cloud 3.

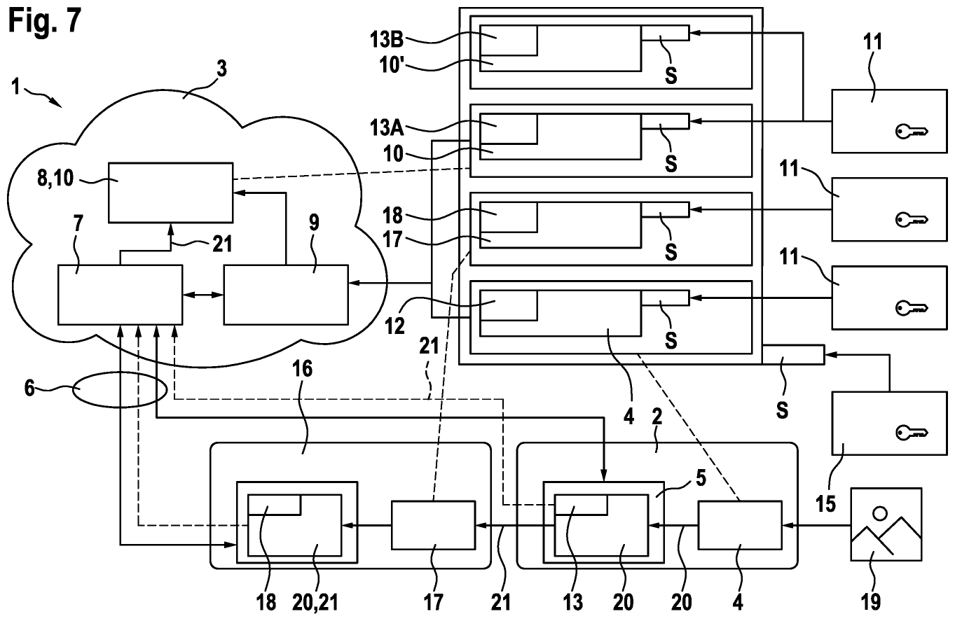

As shown in FIG. 7, the processing component 17, which receives the component data from third-party component 4 and processes it locally, can change the data ID. This allows the marking of already (pre-)processed data so that a hybrid use of the components is possible. For this purpose, the developer signs two cloud processing components, the local processing component 17, and the third-party component 4. The data IDs of the cloud processing components as the service component 10, 10′ are configured such that one directly receives the component data of the third-party component 4 (data ID 13A) and one directly receives the component data of the local processing component 16 (data ID 13B). The processing ID of the local processing component here corresponds to the data ID A.

Alternatively, it is also possible to run the service module in FIG. 6 directly in the cloud 3, provided that this is allowed by the technique used.

Existing Systems

A particular advantage for the use of component bundles with a bundle certificate 15 is that systems that require certain certificates can be used, for example because the component comes from a third-party manufacturer. Mapping in the cloud 3 is still possible. However, the checks of the IDs of the components are highly likely not implemented in the existing system. Therefore, in the cloud, the device management server 7 may need to explicitly link which data are to be processed in which component.

FIG. 1 shows the basic mechanism. A developer produces multiple, distinct components for different purposes (processing on the device and processing in the cloud) and signs them digitally. A data ID annotating the data being sent to the cloud triggers a processing by the corresponding component in charge of the data ID in the cloud. FIG. 2 shows an example of the implementation of the application. FIG. 3 shows the characteristic with bi-directional communication, which allows the cloud processing components to deliver control messages to the device. FIG. 4 shows the characteristic with a component bundle. Existing certificates can be used for the signature of the individual components. The collection of the components is then signed by a further certificate. FIG. 5 shows the use of existing cloud processing modules, such as to visualize standard data types. FIG. 6 shows the use of component bundles for processing on multiple devices. FIG. 7 shows the use of component bundles in hybrid use, where separate processing on a separate device as well as collected processing in the cloud is possible.

1. A method for communication between a third-party component (4) on a user device (2) and a service component (10) in the cloud (3), the method comprising
providing and/or assigning the service component (10) with a data ID (13),
providing component data (20) via the third-party component (4),
marking the component data (20) by the data ID (13) to generate marked component data (21), and
transferring the marked component data (21) to the cloud (3),
wherein the marked component data (21) are assigned to the service component (10) having the data ID (13).

2. The method according to claim 1, wherein the third-party component (4) is signed by a component ID (12).

3. The method according to claim 1, wherein the service component (10) and the third-party component (4) are signed by the same certificate (11) and/or by a certificate (11) from the same developer.

4. The method according to claim 1, wherein the user device (2) comprises a device management component (5), wherein the device management component (5) communicates with a device management server (7) in the cloud (3), wherein the marked component data (21) are routed to the service component (10) via the device management component (5) and the device management server (7).

5. The method according to claim 4, wherein the service component (10) transfers control messages (22) to the third-party component (4) via the device management server (7) and the device management component (5).

6. The method according to claim 4, wherein the third-party component (4) is preferably transferred to the user device (2) with the data ID (13) via the device management server (7) and the device management component (5) for the purposes of installation and/or update.

7. The method according to claim 1, wherein the signed service component (10) and the signed third-party component (4) are signed by a bundle certificate (15).

8. The method according claim 7, wherein the service component (10) is signed by an external certificate.

9. The method according to claim 1, wherein the delivery and/or update of the third-party component (4), the transfer of the marked component data (21), and optionally, by way of supplementation, the control message (22) take place via a common connection (6).

10. The method according to claim 9, wherein the common connection (6) is configured as a secured connection.

11. A network arrangement for communication between a third-party component (4) on a user device (2) and a service component (10) in the cloud (3), the network arrangement comprising:
a user device (2), wherein a third-party component (4) is arranged executably on the user device (2) and is configured so as to provide component data (20),
a service component (10), wherein the service component (10) is arranged executably in the cloud (3), wherein the service component (10) is signed by a data ID, wherein the user device (2) is configured for marking the component data (20) with the data ID (13) in order to generate marked component data (21), wherein the marked component data (21) can be transferred to the cloud (3), wherein the marked component data are assigned to the service component (10) having the data ID (13).

12. (canceled)

13. A non-transitory, computer readable storage medium containing instructions that when executed by a computer cause the computer to control communication between a third-party component (4) on a user device (2) and a service component (10) in the cloud (3), by
providing and/or assigning the service component (10) with a data ID (13),
providing component data (20) via the third-party component (4),
marking the component data (20) by the data ID (13) to generate marked component data (21), and
transferring the marked component data (21) to the cloud (3),
wherein the marked component data (21) are assigned to the service component (10) having the data ID (13).
